(19) United States
(12) Patent Application Publication
(10) Pub. No.: US 2024/0357566 A1
(43) Pub. Date: Oct. 24, 2024

(54) CONTROL CHANNEL MONITORING METHOD, TERMINAL, AND NETWORK-SIDE DEVICE

(71) Applicant: VIVO MOBILE COMMUNICATION CO., LTD., Dongguan (CN)

(72) Inventors: Zhi LU, Dongguan (CN); Xueming PAN, Dongguan (CN); Lihui WANG, Dongguan (CN)

(73) Assignee: VIVO MOBILE COMMUNICATION CO., LTD., Dongguan (CN)

(21) Appl. No.: 18/755,660

(22) Filed: Jun. 26, 2024

Related U.S. Application Data
(63) Continuation of application No. PCT/CN2022/143446, filed on Dec. 29, 2022.

(30) Foreign Application Priority Data
Dec. 30, 2021 (CN) 202111653691.1

(51) Int. Cl. H04W 72/0446; H04W 72/0453; H04W 72/231

(52) U.S. Cl. CPC H04W 72/0446; H04W 72/0453; H04W 72/231

(57) ABSTRACT

This application discloses a control channel monitoring method, a terminal, and a network-side device. The control channel monitoring method includes: receiving, by the terminal, signaling sent by the network-side device, where the signaling is used to indicate a resource type of a time-frequency domain resource; and determining, by the terminal, a to-be-monitored control channel resource based on the resource type, indicated by the signaling, of the time-frequency domain resource.

### CROSS-REFERENCE TO RELATED APPLICATIONS

This application is a continuation of International Application No. PCT/CN2022/143446, filed Dec. 29, 2022, which claims priority to Chinese Patent Application No. 202111653691.1, filed Dec. 30, 2021. The entire contents of each of the above-referenced applications are expressly incorporated herein by reference.

### TECHNICAL FIELD

This application relates to the field of communications technologies, and specifically, to a control channel monitoring method, a terminal, and a network-side device.

### BACKGROUND

Compared with a previous mobile communication system, a future 5G mobile communication system needs to adapt to more diverse scenarios and service requirements. Main 5G scenarios include: an Enhanced Mobile Broadband (eMBB), Ultra-reliable and Low Latency Communications (URLLC), and Massive Machine Type Communication (mMTC). The scenarios require high reliability, a low latency, a large bandwidth, and wide coverage for the system. In New Radio (NR), a network configures a Bandwidth Part (BWP) and/or a carrier for User Equipment (UE) for data transmission. After the network configures the BWP, the BWP corresponds to determined UL and DL resources, and a transmission direction of a time-frequency domain resource is determined through a configuration or an indication.

In related technologies, a Control Resource set (coreset) configured by the network for the UE falls within a Downlink (DL) BWP. However, when some resources of the coreset are changed to an Uplink (UL), monitoring a Physical Downlink Control Channel (PDCCH) in the coreset by the UE is affected, resulting in low control channel monitoring efficiency.

### SUMMARY

Embodiments of this application provide a control channel monitoring method, a terminal, and a network-side device.

According to a first aspect, a control channel monitoring method is provided, where the method includes:

receiving, by a terminal, signaling sent by a network-side device, where the signaling is used to indicate a resource type of a time-frequency domain resource; and

determining, by the terminal, a to-be-monitored control channel resource based on the resource type, indicated by the signaling, of the time-frequency domain resource.

According to a second aspect, a control channel monitoring method is provided, where the method includes:

sending, by a network-side device, signaling to a terminal, where the signaling is used to indicate a resource type of a time-frequency domain resource.

According to a third aspect, a control channel monitoring apparatus is provided, where the apparatus includes:

a receiving module, configured to receive signaling sent by a network-side device, where the signaling is used to indicate a resource type of a time-frequency domain resource; and

a determining module, configured to determine a to-be-monitored control channel resource based on the resource type, indicated by the signaling, of the time-frequency domain resource.

According to a fourth aspect, a control channel monitoring apparatus is provided, where the apparatus includes:

a sending module, configured to send signaling to a terminal, where the signaling is used to indicate a resource type of a time-frequency domain resource.

According to a fifth aspect, a terminal is provided, where the terminal includes a processor and a memory, the memory stores a program or an instruction executable by the processor, and when the program or the instruction is executed by the processor, the steps of the method according to the first aspect is implemented.

According to a sixth aspect, a terminal is provided, including a processor and a communication interface, where the communication interface is configured to receive signaling sent by a network-side device, and the signaling is used to indicate a resource type of a time-frequency domain resource; and

the processor is configured to determine a to-be-monitored control channel resource based on the resource type, indicated by the signaling, of the time-frequency domain resource.

According to a seventh aspect, a network-side device is provided, where the network-side device includes a processor and a memory, the memory stores a program or an instruction executable by the processor, and when the program or the instruction is executed by the processor, the steps of the method according to the second aspect are implemented.

According to an eighth aspect, a network-side device is provided, including a processor and a communication interface, where the communication interface is configured to send signaling to a terminal, and the signaling is used to indicate a resource type of a time-frequency domain resource.

According to a ninth aspect, a control channel monitoring system is provided, including a terminal and a network-side device, where the terminal may be configured to perform the steps of the method according to the first aspect, and the network-side device may be configured to perform the steps of the method according to the second aspect.

According to a tenth aspect, a readable storage medium is provided, where a program or an instruction is stored in the readable storage medium, and when the program or the instruction is executed by a processor, the steps of the method according to the first aspect or the steps of the method according to the second aspect are implemented.

According to an eleventh aspect, a chip is provided, where the chip includes a processor and a communication interface, the communication interface is coupled to the processor, and the processor is configured to run a program or an instruction, to implement the method according to the first aspect or the second aspect.

According to a twelfth aspect, a computer program product is provided, where the computer program product is stored in a storage medium, and the computer program/program product is executed by at least one processor to implement the steps of the method according to the first aspect, or the steps of the method according to the second aspect.

In the embodiments of this application, the network-side device indicates the resource type of the time-frequency domain resource by using the signaling. After the terminal receives the signaling sent by the network-side device, the resource type, indicated by the signaling, of the time-frequency domain resource can be obtained by parsing the signaling, so that the terminal can determine the to-be-monitored control channel resource based on the resource type of the time-frequency domain resource, thereby increasing control channel monitoring efficiency, increasing coverage, and reducing a latency.

### BRIEF DESCRIPTION OF DRAWINGS

FIG. 1 is a schematic diagram of a wireless communication system to which embodiments of this application are applicable;

FIG. 2 is a flowchart 1 of a control channel monitoring method according to an embodiment of this application;

FIG. 3 is a schematic diagram 1 of a transmission direction of a time-frequency domain resource according to an embodiment of this application;

FIG. 4 is a schematic diagram 2 of a transmission direction of a time-frequency domain resource according to an embodiment of this application;

FIG. 5 is a schematic diagram 3 of a transmission direction of a time-frequency domain resource according to an embodiment of this application;

FIG. 6 is a schematic diagram 4 of a transmission direction of a time-frequency domain resource according to an embodiment of this application;

FIG. 7 is a schematic diagram 5 of a transmission direction of a time-frequency domain resource according to an embodiment of this application;

FIG. 8 is a schematic diagram 6 of a transmission direction of a time-frequency domain resource according to an embodiment of this application;

FIG. 9 is a flowchart 2 of a control channel monitoring method according to an embodiment of this application;

FIG. 10 is a schematic diagram 1 of a structure of a control channel monitoring apparatus according to an embodiment of this application;

FIG. 11 is a schematic diagram 2 of a structure of a control channel monitoring apparatus according to an embodiment of this application;

FIG. 12 is a schematic diagram of a structure of a communication device according to an embodiment of this application;

FIG. 13 is a schematic diagram of a structure of a terminal according to an embodiment of this application; and

FIG. 14 is a schematic diagram of a structure of a network-side device according to an embodiment of this application.

### DETAILED DESCRIPTION

The following clearly describes technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that the terms used in this way are interchangeable in appropriate circumstances such that the embodiments of this application can be implemented in other orders than the order illustrated or described herein. In addition, objects distinguished by “first” and “second” are generally of a same type, and the number of objects is not limited, for example, there may be one or more first objects. In addition, in the specification and claims, “and/or” represents at least one of connected objects, and a character “/” generally represents an “or” relationship between associated objects.

It should be noted that technologies described in the embodiments of this application are not limited to a long time evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The described technologies may be applied to both the systems and the radio technologies mentioned above as well as to other systems and radio technologies. A New Radio (NR) system is described in the following descriptions for illustrative purposes, and an NR terminology is used in most of the following descriptions, although the technologies can also be applied to a communication system other than an NR system application, for example, a 6th Generation (6G) communication system.

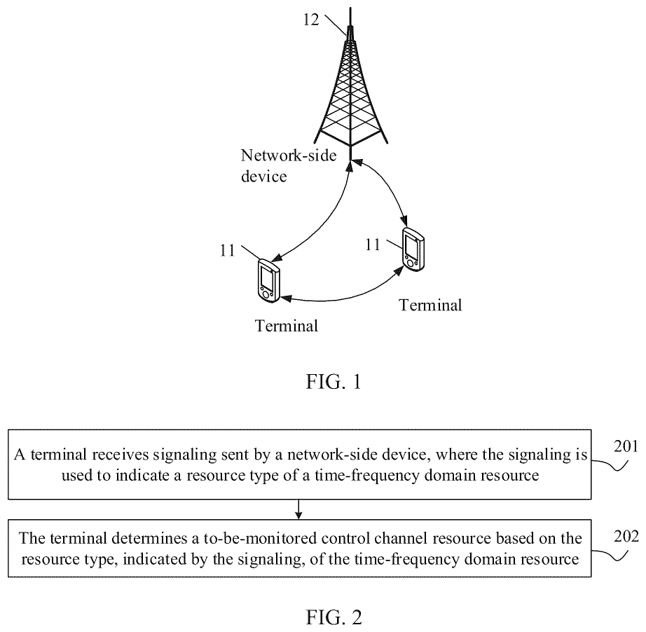

FIG. 1 is a schematic diagram of a wireless communication system to which the embodiments of this application are applicable. The wireless communication system shown in FIG. 1 includes a terminal 11 and a network-side device 12. The terminal 11 may be a terminal side device such as a mobile phone, a tablet personal computer, a laptop computer or a notebook computer, a personal digital assistant (PDA), a palm computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart household (a household device with a wireless communication function, such as a refrigerator, a television, a washing machine, or furniture), a game console, a personal computer (PC), a teller machine, or a self-service machine, and the wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wireless Fidelity (WiFi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. As long as a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a local NEF (Local NEF or L-NEF), a Binding Support Function (BSF), an Application Function (AF), or the like. It should be noted that, in the embodiments of this application, only a core network device in the NR system is used as an example for description, and a specific type of the core network device is not limited.

With reference to the accompanying drawings, the following describes in detail a control channel monitoring method provided in an embodiment of this application by using some embodiments and application scenarios thereof.

The control channel monitoring method provided in this embodiment of this application may be applied to a full-duplex/flexible-duplex scenario. The network-side device indicates a resource type of a time-frequency domain resource by using signaling. After the terminal receives the signaling sent by the network-side device, the resource type, indicated by the signaling, of the time-frequency domain resource can be obtained by parsing the signaling, so that the terminal can determine a to-be-monitored control channel resource based on the resource type of the time-frequency domain resource, thereby increasing control channel monitoring efficiency, increasing coverage, and reducing a latency.

FIG. 2 is a schematic flowchart 1 of a control channel monitoring method according to an embodiment of this application. As shown in FIG. 2, the method includes step 201 and step 202.

Step 201: A terminal receives signaling sent by a network-side device, where the signaling is used to indicate a resource type of a time-frequency domain resource.

Step 202: The terminal determines a to-be-monitored control channel resource based on the resource type, indicated by the signaling, of the time-frequency domain resource.

It should be noted that this embodiment of this application may be applied to a full-duplex/flexible-duplex scenario. The terminal includes but is not limited to the foregoing listed types of the terminal 11. The network-side device includes but is not limited to the foregoing listed types of the network-side device 12. This is not limited in this embodiment of this application. The time-frequency domain resource is some or all of control channel resources configured by the network-side device for the terminal. It may be understood that the terminal may determine to perform the following operation based on at least one of protocol pre-definition, terminal autonomously performing determining and notifying a network, or higher-layer pre-configuration or network configuration: determining the to-be-monitored control channel resource based on the resource type, indicated by the signaling, of the time-frequency domain resource.

In this embodiment of this application, the signaling may include at least one of the following:

(1) Radio Resource Control (RRC);

(2) group common Downlink Control Information (DCI);

(3) first scheduling DCI, used to schedule a single terminal;

(4) second scheduling DCI, used to schedule a plurality of terminals in at least one cell in a cell group or at least one carrier in a carrier group; or

(5) Medium Access Control (MAC) Control Element (CE) signaling.

In practice, the signaling may include at least one of the following:

(a) indication information, used to indicate a resource type of a time-frequency domain resource; or

(b) determining information, used to determine information about a resource type of a time-frequency domain resource.

In some embodiments, the indication information includes a frequency domain format indicator FFI, and the FFI is used to indicate a time-frequency domain resource, and a resource type of the time-frequency domain resource.

In some embodiments, the resource type includes at least one of the following:

(1) an uplink resource;

(2) a downlink resource;

(3) an unknown resource, when a network-side device network indicates to a terminal that a resource set (a PRB set) is an unknown resource, it indicates that it is not determined, at a moment at which the terminal receives an indication from the network-side device, whether the resource set is available; and whether the unknown resource can be available subsequently is based on a further indication or configuration of the network-side device; and

it should be noted that both the unknown resource and a flexible resource may be subsequently indicated as a DL or a UL; and however, the unknown resource is different from the flexible resource: The flexible resource is usually a resource that is indicated as being flexible; and the UL resource or the DL resource may be indicated as an unknown resource, but cannot be indicated as a flexible resource;

(4) an unavailable resource, when the network-side device network indicates to a terminal that a resource set (a PRB set) is an unavailable resource, it indicates that the resource set is unavailable; and for example, a resource set is indicated for SSB transmission; or after a resource set is semi-statically indicated as a flexible symbol or slot, a dynamic SFI is also indicated as a flexible symbol or slot, and in this case, the resource set is an unavailable resource;

(5) resource identifier information, where the resource identifier information is used to identify a target control channel resource in a target slot, and the control channel resource is, for example, a coreset; or

(6) resource monitoring information, where the resource monitoring information is used to indicate whether to monitor a control channel resource in the target slot.

In the control channel monitoring method provided in this embodiment of this application, the network-side device indicates the resource type of the time-frequency domain resource by using the signaling. After the terminal receives the signaling sent by the network-side device, the resource type, indicated by the signaling, of the time-frequency domain resource can be obtained by parsing the signaling, so that the terminal can determine the to-be-monitored control channel resource based on the resource type of the time-frequency domain resource, thereby increasing control channel monitoring efficiency, increasing coverage, and reducing a latency.

In practice, the signaling sent by the network-side device to the terminal may include at least one of the following:

(a) indication information, used to indicate a resource type of a time-frequency domain resource; or

(b) determining information, used to determine information about a resource type of a time-frequency domain resource.

In some embodiments, the indication information includes a frequency domain format indicator (FFI), and the FFI is used to indicate a time-frequency domain resource, and a resource type of the time-frequency domain resource. For example, when the FFI indicates an uplink resource, the FFI may indicate that a PRB in at least one slot is used for uplink transmission; or when the FFI indicates a downlink resource, the FFI may indicate that a PRB in at least one slot is used for downlink transmission.

In some embodiments, the indication information may be semi-statically configured by or dynamically indicated by the network-side device, for example, indicated by using RRC signaling, group common DCI, or scheduling DCI; and the indication information may be periodically indicated or configured to take effect periodically.

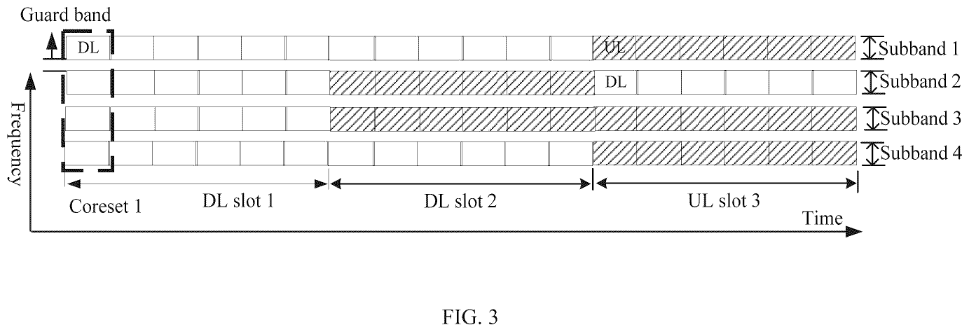

FIG. 3 is a schematic diagram 1 of a transmission direction of a time-frequency domain resource according to an embodiment of this application. A bandwidth shown in FIG. 3 includes 96 Physical Resource Block (PRB), each subband (or subband set) includes 20 PRBs, and a guard band includes six PRBs. A bandwidth of the guard band and the FFI may be determined together or separately in at least one of the following manners: protocol predefinition; higher-layer pre-definition/pre-configuration; a network-side device performing a dynamic indication or a semi-static signaling notification; or a terminal performing determining autonomously.

As shown in FIG. 3, an FFI indicates the following: In a slot 1, subbands 1 to 4 are all DLs; in a slot 2, subbands 1 and 4 are DLs, and subbands 2 and 3 are ULs; and in a slot 3, subbands 1, 3, and 4 are ULs, a subband 2 is a DL. For a DL subband in a UL BWP, a network may configure a DL BWP as a reference BWP. For a UL subband in the DL BWP, the network may configure the UL BWP as a reference BWP.

With reference to the bandwidth shown in FIG. 3, the network-side device configures a coreset 1 including 96 RBs for the terminal. All PRBs on the subbands 1 to 4 in the coreset 1 in the slot 1 are effective, PRBs on only the subbands 1 and 4 in the slot 2 are effective, and a PRB on only the subband 2 in the slot 3 is effective. Obviously, only some CCEs or PDCCH candidates in the coreset 1 in the slots 2 and 3 are effective. The terminal may determine a downlink resource indicated by the FFI in the coreset 1 (for example, the subbands 1 to 4 in the slot 1, the subbands 1 and 4 in the slot 2, and the subband 2 in the slot 3) as the to-be-monitored control channel resource.

Based on this embodiment of this application, the terminal determines, based on a transmission direction of a control channel resource (such as a coreset, a PDCCH candidate, or a CCE) indicated by the FFI, a control channel resource (a downlink resource) whose transmission direction is a downlink direction as the to-be-monitored control channel resource. Then, the terminal monitors a control channel on the to-be-monitored control channel resource, so that control channel monitoring efficiency can be increased.

It should be noted that, in this embodiment of this application, after the terminal determines the to-be-monitored control channel resource based on the resource type, indicated by the signaling, of the time-frequency domain resource, the terminal may perform a process of determining PDCCH overbooking and dropping based on the to-be-monitored control channel resource, so that determining efficiency can be increased.

The following describes a manner in which the terminal determines the to-be-monitored control channel resource in this embodiment of this application. An implementation in which the terminal determines the to-be-monitored control channel resource based on the resource type, indicated by the signaling, of the time-frequency domain resource may include any one of the following:

Manner 1: The terminal determines the to-be-monitored control channel resource based on a granularity and the resource type, indicated by the signaling, of the time-frequency domain resource.

In practice, the granularity includes at least one of the following: a PDCCH candidate granularity, a control channel element (CCE) granularity, or a coreset granularity. The terminal determines effectiveness of a PDCCH resource based on a network configuration by using one of the foregoing granularities. The terminal may determine the to-be-monitored control channel resource based on based on the network configuration, and the resource type, indicated by the signaling, of the time-frequency domain resource and by using one of the foregoing granularities.

In some embodiments, the granularity may be determined in at least one of the following manners: protocol pre-definition; higher-layer pre-definition/pre-configuration; the network-side device performing a configuration; or the terminal performing determining autonomously.

Manner 2: The terminal determines the to-be-monitored control channel resource in a CCE to a resource element group (REG) mapping (CCE-REG mapping) mode used by the coreset and based on the resource type, indicated by the signaling, of the time-frequency domain resource. The CCE-REG mapping mode includes: interleaving or non-interleaving.

Herein, the foregoing two manners are separately described below.

For the foregoing manner 1, an implementation in which the terminal determines the to-be-monitored control channel resource based on the granularity and the resource type, indicated by the signaling, of the time-frequency domain resource may include at least one of the following:

Implementation 1: When the granularity is the PDCCH candidate granularity and the signaling indicates that all resources of a PDCCH candidate are downlink resources, the terminal determines the PDCCH candidate as the to-be-monitored control channel resource.

When the granularity is the PDCCH candidate granularity, if all resources of a PDCCH candidate are indicated as DL resources, the terminal determines that the PDCCH candidate is an effective PDCCH resource, determines the PDCCH candidate as the to-be-monitored control channel resource, and then monitors the PDCCH candidate. If a PDCCH candidate is an effective PDCCH resource, the PDCCH candidate may be referred to as an effective PDCCH candidate.

However, if some or all of resources of a PDCCH candidate are indicated as any one of the UL resource, the unavailable resource, and the unknown resource, the terminal determines that the PDCCH candidate is ineffective and is not an effective PDCCH resource, and the PDCCH candidate does not belong to the to-be-monitored control channel resource. In this case, the terminal does not monitor the PDCCH candidate.

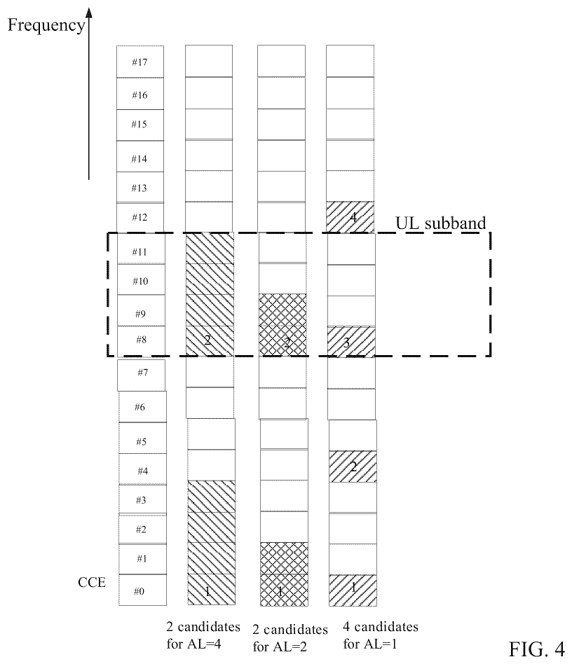

With reference to FIG. 4, an example is described. FIG. 4 is a schematic diagram 2 of a transmission direction of a time-frequency domain resource according to an embodiment of this application. As shown in FIG. 4, a network-side device configures a coreset for a terminal, and configures three aggregation levels in one search space set associated with the coreset. Two PDCCH candidates are configured at an aggregation level 4, two PDCCH candidates are configured at an aggregation 2, and four PDCCH candidates are configured at an aggregation level 1.

The network-side device configures a UL subband for the terminal, and the UL subband overlaps a PRB where CCEs 8 to 11 in the coreset are located. That is, PRBs included in the CCEs 8 to 11 in this case are UL resources and cannot be used for DL transmission.

As shown in FIG. 4, when the network-side device configures the terminal to determine an effective PDCCH resource based on a PDCCH candidate granularity:

for the aggregation level 4, a PDCCH candidate 2 is ineffective and a PDCCH candidate 1 is an effective PDCCH resource;

for the aggregation level 2, a PDCCH candidate 2 is ineffective and a PDCCH candidate 1 is an effective PDCCH resource; and for the aggregation level 1, a PDCCH candidate 3 is ineffective and PDCCH candidates 1, 2, and 4 are effective PDCCH resources.

The terminal may determine, as the to-be-monitored control channel resource, an effective PDCCH candidate (all resources of the effective PDCCH candidate are downlink resources) (for example, the PDCCH candidate 1 with the aggregation level of 4, the PDCCH candidate 1 with the aggregation level of 2, and the PDCCH candidates 1, 2 and 4 with the aggregation level of 3) in the coreset except an uplink resource indicated by the UL subband. Then, the terminal monitors a control channel on the to-be-monitored control channel resource, so that control channel monitoring efficiency can be increased.

In practice, after the terminal determines the to-be-monitored control channel resource based on the granularity and the resource type, indicated by the signaling, of the time-frequency domain resource, the terminal may perform a process of determining PDCCH overbooking and dropping based on the granularity and the to-be-monitored control channel resource.

For example, when the granularity is a PDCCH candidate granularity, the terminal determines to perform PDCCH overbooking and dropping based on the to-be-monitored control channel resource. Herein, with reference to FIG. 4, an example is described as follows:

If the terminal determines the effective PDCCH resource (an available PDCCH resource) based on the PDCCH candidate granularity and a network configuration or a pre-defined rule, the terminal determines PDCCH overbooking/dropping based on the effective PDCCH resource. That is, if some or all of resources of a PDCCH candidate are indicated as any one of a UL resource, an unavailable resource, and an unknown resource, the PDCCH candidate is not counted in a quantity of blind detections or channel estimations, that is, is not used during determining of PDCCH overbooking.

During PDCCH overbooking calculation, only the effective PDCCH resource is considered. For example, for the aggregation level 4, the PDCCH candidate 2 is not considered during the PDCCH overbooking calculation. If the terminal calculates that the quantity of PDCCH blind detections or channel estimations exceeds a monitoring capability of the terminal, that is, overbooking occurs, the terminal discards all PDCCH candidates in search space with a relatively high search space ID, until the quantity of blind detections or channel estimations does not exceed the monitoring capability of the terminal. It should be noted that when the terminal performs PDCCH overbooking monitoring, the PDCCH overbooking monitoring may be performed per slot or per span (or a first span) based on the network configuration.

Implementation 2: When the granularity is the CCE granularity and the signaling indicates that all resources of a CCE are downlink resources, the terminal determines the CCE as the to-be-monitored control channel resource.

Herein, an example in which the granularity is the CCE granularity is used for description.

When the granularity is the CCE granularity, if all resources of a CCE are indicated as DL resources, the terminal determines that the CCE is an effective PDCCH resource, determines the CCE as the to-be-monitored control channel resource, and then monitors the CCE. If a CCE is an effective PDCCH resource, the CCE may be referred to as an effective CCE.

However, if some or all of resources of a CCE are indicated as any one of the UL resource, the unavailable resource, and the unknown resource, the terminal determines that the CCE is ineffective and is not an effective PDCCH resource, and the CCE does not belong to the to-be-monitored control channel resource. In this case, the terminal does not monitor the CCE, that is, the CCE is not used for decoding a PDCCH candidate on which the CCE is located.

It should be noted that when the terminal determines that a CCE is not an effective PDCCH resource, the terminal may determine, based on at least one of protocol pre-definition, terminal autonomously performing determining and notifying a network, or a higher-layer pre-configuration or network configuration, whether other CCEs on the PDCCH candidate on which the CCE is located can be used to decode the corresponding PDCCH candidate. For example, the network-side device may configure at least one of the following policies:

(1) If a PDCCH candidate includes at least one effective CCE, an effective CCE on the PDCCH candidate can be used for decoding the PDCCH candidate.

(2) If a quantity of effective CCEs on a PDCCH candidate is greater than or equal to M, an effective CCE on the PDCCH candidate can be used for decoding the PDCCH candidate, where M is a positive integer that is configured on a network or predefined. If a quantity of effective CCEs on a PDCCH candidate is less than M, the PDCCH candidate is ineffective.

(3) If some or all of resources of at least one CCE on a PDCCH candidate are indicated as any one of the UL resource, the unavailable resource, and the unknown resource, the terminal does not monitor the PDCCH candidate.

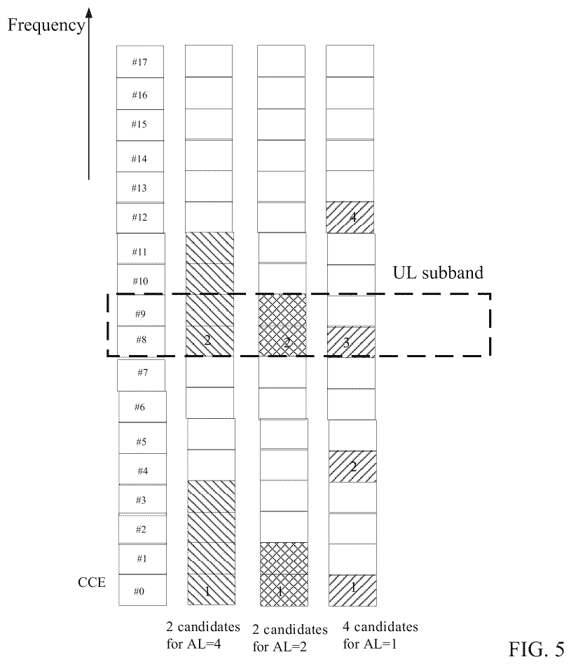

With reference to FIG. 5, an example is described. FIG. 5 is a schematic diagram 3 of a transmission direction of a time-frequency domain resource according to an embodiment of this application. As shown in FIG. 5, a network-side device configures a coreset for a terminal, and configures three aggregation levels in one search space set associated with the coreset. Two PDCCH candidates are configured at an aggregation level 4, two PDCCH candidates are configured at an aggregation level 2, and four PDCCH candidates are configured at an aggregation level 1.

The network-side device configures a UL subband for the terminal, and the UL subband overlaps a PRB where CCEs 8 and 9 in the coreset are located. That is, PRBs included in the CCEs 8 and 9 in this case are UL resources and cannot be used for DL transmission.

As shown in FIG. 5, when the network-side device configures the terminal to determine an effective PDCCH resource based on a CCE granularity:

for the aggregation level 4, CCEs 8 and 9 on a PDCCH candidate 2 are ineffective, CCEs 10 and 11 on the PDCCH candidate 2 are effective PDCCH resources (that is, the terminal may decode the PDCCH candidate 2 based on the CCE 10 and the CCE 11), and all CCEs on a PDCCH candidate 1 are effective PDCCH resources;

for the aggregation level 2, all CCEs on a PDCCH candidate 2 are ineffective and all CCEs on a PDCCH candidate 1 are effective PDCCH resources; and for the aggregation level 1, a CCE on a PDCCH candidate 3 is ineffective and CCEs on PDCCH candidates 1, 2, and 4 are effective PDCCH resources.

The terminal may determine, as the to-be-monitored control channel resource, an effective PDCCH resource (some or all of effective PDCCH resources are downlink resources) (for example, all the CCEs on the PDCCH candidate 1 and the CCEs 10 and 11 on the PDCCH candidate 2 at the aggregation level 4, all the CCEs on the PDCCH candidate 1 at the aggregation level 2, and CCEs of the PDCCH candidates 1, 2, and 4 at the aggregation level 3) in the coreset except an uplink resource indicated by the UL subband. Then, the terminal monitors a control channel on the to-be-monitored control channel resource, so that control channel monitoring efficiency can be increased.

In practice, after the terminal determines the to-be-monitored control channel resource based on the granularity and the resource type, indicated by the signaling, of the time-frequency domain resource, the terminal may perform a process of determining PDCCH overbooking and dropping based on the granularity and the to-be-monitored control channel resource.

For example, when a granularity is a CCE granularity and all resources of at least one CCE of a PDCCH candidate on which the to-be-monitored control channel resource is located are downlink resources, the terminal determines to perform PDCCH overbooking and dropping based on an effective CCE included in the PDCCH candidate;

when a granularity is a CCE granularity and all resources of at least M CCEs of a PDCCH candidate on which the to-be-monitored control channel resource is located are downlink resources, the terminal determines to perform PDCCH overbooking and dropping based on an effective CCE included in the PDCCH candidate, where M is a positive integer that is configured on a network or pre-defined; or

when a granularity is a CCE granularity and all resources of all CCEs of a PDCCH candidate on which the to-be-monitored control channel resource is located are downlink resources, the terminal determines to perform PDCCH overbooking and dropping based on the PDCCH candidate.

During the PDCCH overbooking calculation, only a PDCCH candidate with an effective CCE is considered. An ineffective PDCCH candidate is not counted in the quantity of blind detections or channel estimations, that is, is not used during determining of PDCCH overbooking.

The effective CCE refers to that a resource of the CCE is not indicated as any one of the UL resource, the unavailable resource, and the unknown resource. However, the PDCCH candidate with the effective CCE is defined as any one of the following:

(1) if a PDCCH candidate includes at least one effective CCE, the PDCCH candidate is referred to as an effective PDCCH candidate;

(2) if all CCEs included in a PDCCH candidate are effective, the PDCCH candidate is referred to as an effective PDCCH candidate; and

(3) if a quantity of effective CCEs on a PDCCH candidate is greater than or equal to M, the PDCCH candidate is referred to as an effective PDCCH candidate, where M is a positive integer that is configured on a network or pre-defined.

Herein, with reference to FIG. 5, an example is described:

For the aggregation level 4, the CCEs 10 and 11 on the PDCCH candidate 2 are effective PDCCH resources. Therefore, the CCEs 10 and 11 on the PDCCH candidate 2 are used during the PDCCH overbooking calculation. Because all the CCEs on the PDCCH candidate 1 are effective PDCCH resources, all the CCEs on the PDCCH candidate 1 are used during the PDCCH overbooking calculation.

For the aggregation level 2, because all the CCEs on the PDCCH candidate 2 are ineffective, the PDCCH candidate 2 is not considered during the PDCCH overbooking calculation. Because all the CCEs on the PDCCH candidate 1 are effective PDCCH resources, all the CCEs on the PDCCH candidate 1 are used during the PDCCH overbooking calculation.

Implementation 3: When the granularity is the coreset granularity and the signaling is used to indicate that all resources of a coreset are downlink resources, the terminal determines all PDCCH candidates in the coreset as the to-be-monitored control channel resource.

When the network-side device configures the terminal to determine an effective PDCCH resource based on the coreset granularity, if all resources of a coreset are indicated as DL resources, the terminal determines that the coreset is an effective PDCCH resource, determines the coreset as the to-be-monitored control channel resource, and then monitors the coreset. If a coreset is an effective PDCCH resource, the coreset may be referred to as an effective coreset.

However, if some or all of resources of a coreset are indicated as any one of the UL resource, the unavailable resource, and the unknown resource, the terminal determines that the coreset is ineffective and is not an effective PDCCH resource, and the coreset does not belong to the to-be-monitored control channel resource. In this case, the terminal does not monitor the coreset, that is, the coreset is not used for decoding a PDCCH candidate. In this case, all the PDCCH candidates included in the coreset are discarded, and the terminal does not monitor all the PDCCH candidates corresponding to the coreset, that is, PDCCH candidates and CCEs on all SSSes associated with the coreset. UE does not decode a PDCCH in the coreset.

In practice, after the terminal determines the to-be-monitored control channel resource based on the granularity and the resource type, indicated by the signaling, of the time-frequency domain resource, the terminal may perform a process of determining PDCCH overbooking and dropping based on the granularity and the to-be-monitored control channel resource.

For example, when a granularity is a coreset granularity, the terminal determines to perform PDCCH overbooking and dropping based on the to-be-monitored control channel resource.

If some or all of resources of a CCE are indicated as any one of the UL resource, the unavailable resource, and the unknown resource, the terminal determines that the coreset is ineffective, and during the PDCCH overbooking calculation, none of PDCCH candidates of the coreset is considered.

For the foregoing manner 2, an implementation in which the terminal determines the to-be-monitored control channel resource in a CCE-REG mapping mode used by the coreset and based on the resource type, indicated by the signaling, of the time-frequency domain resource may include at least one of the following:

(a) when the CCE-REG mapping mode used by the coreset is interleaving, determining, by the terminal as the to-be-monitored control channel resource, all PDCCH candidates in the coreset whose resources are all the downlink resources and that is indicated by the signaling.

When the CCE-REG mapping mode of the coreset is interleaving, if all resources of a coreset are indicated as DL resources, the terminal determines that the coreset is an effective PDCCH resource, determines the coreset as the to-be-monitored control channel resource, and then monitors the coreset.

However, if some or all of the resources of the coreset are indicated as any one of the UL resource, the unavailable resource, and the unknown resource, the terminal determines that the coreset is ineffective and is not an effective PDCCH resource, and the coreset does not belong to the to-be-monitored control channel resource. In this case, the terminal does not monitor the coreset, that is, the coreset is not used for decoding a PDCCH.

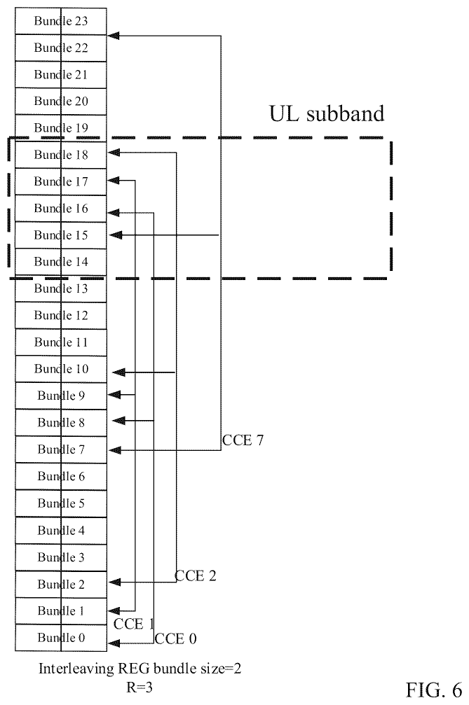

In some embodiments, if some or all of resources of a CCE of the coreset are indicated as any one of the UL resource, the unavailable resource, and the unknown resource, the terminal determines that the CCE is ineffective, that is, the CCE is not used for decoding a PDCCH. With reference to FIG. 6, an example is used for description. FIG. 6 is a schematic diagram 4 of a transmission direction of a time-frequency domain resource according to an embodiment of this application. As shown in FIG. 6, a network-side device configures a coreset for a terminal. A CCE-REG mapping mode of the coreset is interleaving. When a UL subband occupies 10 RBs, that is, bundles 14 to 18, none of CCEs associated with the bundles 14 to 18 in the coreset are used to decode a PDCCH.

In some embodiments, the terminal excludes an affected REG bundle and decodes a PDCCH by using an unaffected REG bundle. That is, if a REG bundle is changed to any one of a UL resource, an unavailable resource, and an unknown resource, the REG bundle is not subjected to PDCCH decoding, and the PDCCH is decoded by using the unaffected REG bundle.

(b) When the CCE-REG mapping mode used by the coreset is non-interleaving, the terminal determines, as the to-be-monitored control channel resource, the CCE whose resources are all the downlink resources and that is indicated by the signaling. In some embodiments, the to-be-monitored control channel resource is determined by using the method in the manner 1.

An implementation in which when the resource type includes resource identifier information, the terminal determines the to-be-monitored control channel resource based on the resource type, indicated by the signaling, of the time-frequency domain resource is described below.

When the resource type, indicated by the signaling, of the time-frequency domain resource includes the resource identifier information, the terminal determines, as the to-be-monitored control channel resource, a target control channel resource, identified by the resource identifier information, in a target slot. The resource identifier information is used to identify the target control channel resource in the target slot. The resource identifier information is, for example, a coreset number. The network-side device may indicate the coreset number by using the signaling, which is applicable to any one of the following cases:

case 1: a DL BWP of the terminal (no UL subband and unavailable symbol);

case 2: a DL subband of a UL BWP; and

case 3: a DL BWP including a UL subband.

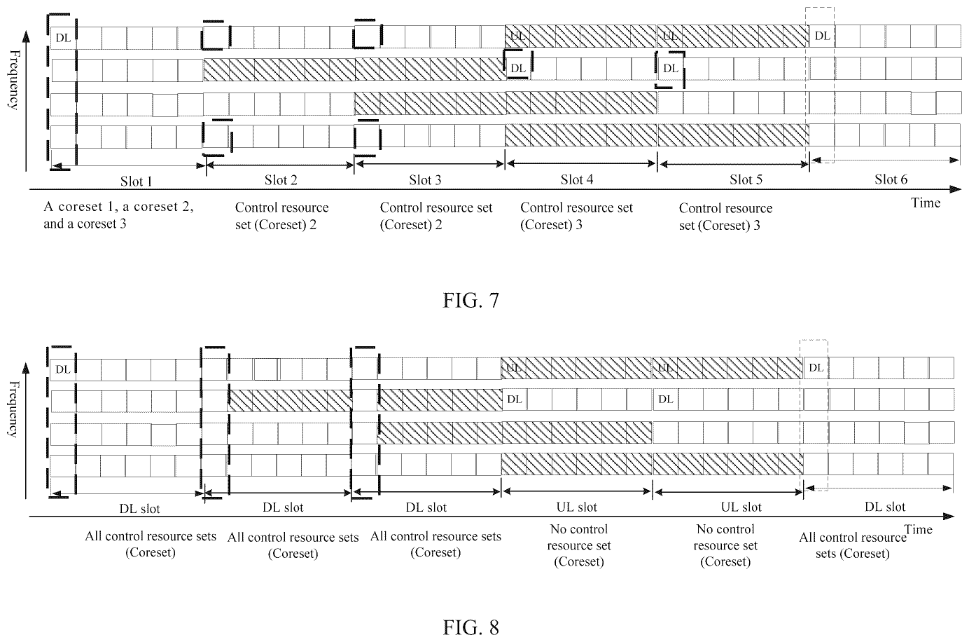

With reference to FIG. 7, an example is described. FIG. 7 is a schematic diagram 5 of a transmission direction of a time-frequency domain resource according to an embodiment of this application. As shown in FIG. 7, a network-side device configures coresets 1 to 4 for a terminal. The network-side device indicates the following by using signaling: In a slot 1, the terminal monitors the coresets 1, 2, and 3; in a slot 2 and a slot 3, the terminal monitors only the coreset 2; and in a slot 4 and a slot 5, the terminal monitors only the coreset 3.

It should be noted that a number of a coreset monitored by the terminal in each slot may be notified by using RRC signaling, MAC CE signaling, and dynamic signaling. The dynamic signaling may include group common signaling and UE specific signaling.

For example, the network-side device may periodically configure the number of the coreset monitored in each slot. The network-side device may indicate, by using the dynamic signaling, the number of the coreset monitored in at least one slot. Refer to Table 1.

TABLE 1

| | | | | |
|---|---|---|---|---|
| Slot number | Slot n | Slot n + 1 | Slot n + 2 | . . . |

| | | | |
|---|---|---|---|
| Number of a monitored coreset | 1 | 2 | 3 |

An implementation in which when the resource type includes resource monitoring information, the terminal determines the to-be-monitored control channel resource based on the resource type, indicated by the signaling, of the time-frequency domain resource is described below.

When the resource type includes the resource monitoring information, and the resource monitoring information indicates that a control channel resource is monitored in a target slot, the terminal determines all time-frequency domain resources in the target slot as the to-be-monitored control channel resource.

For example, the network-side device may indicate the terminal whether to monitor a PDCCH in at least one slot. As shown in Table 2, 1 indicates yes, that is, the terminal is indicated to monitor a PDCCH in a corresponding slot; and 0 indicates no, that is, the terminal is indicated not to monitor a PDCCH in a corresponding slot.

TABLE 2

| | | | | |
|---|---|---|---|---|
| Slot number | Slot n | Slot n + 1 | Slot n + 2 | . . . |

| | | | |
|---|---|---|---|
| Whether to monitor a PDCCH | 1 | 0 | 1 |

In an implementation, the terminal does not expect the coreset to be configured on an uplink bandwidth part (UL BWP) or a downlink DL BWP including an uplink subband.

With reference to FIG. 8, an example is described. FIG. 8 is a schematic diagram 6 of a transmission direction of a time-frequency domain resource according to an embodiment of this application. As shown in FIG. 8, in a DL symbol indicated by TDD-UL-DL-ConfigurationCommon or TDD-UL-DL-ConfigurationDedicated, UE does not expect a coreset resource on a PDCCH monitoring occasion to be changed to a UL. In FIG. 8, all coreset resources in each DL slot are effective PDCCH resources, and the terminal determines all the coreset resources corresponding to the DL slot as the to-be-monitored control channel resources.

In some embodiments, the UE does not expect to monitor a PDCCH in a UL symbol indicated by TDD-UL-DL-ConfigurationCommon, including a DL subband in the UL symbol.

In some embodiments, the UE does not expect to monitor a PDCCH in a UL symbol indicated by TDD-UL-DL-ConfigurationDedicated, including a DL subband in the UL symbol.

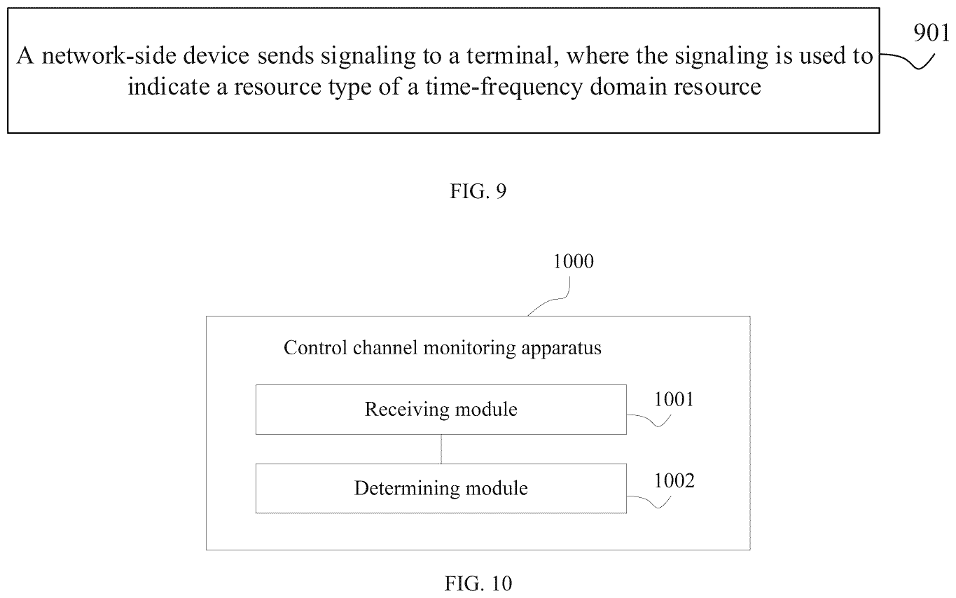

FIG. 9 is a schematic flowchart 2 of a control channel monitoring method according to an embodiment of this application. As shown in FIG. 9, the method includes the following step:

Step 901: A network-side device sends signaling to a terminal, where the signaling is used to indicate a resource type of a time-frequency domain resource.

In the control channel monitoring method provided in this embodiment of this application, the network-side device indicates the resource type of the time-frequency domain resource by using the signaling. After the terminal receives the signaling sent by the network-side device, the resource type, indicated by the signaling, of the time-frequency domain resource can be obtained by parsing the signaling, so that the terminal can determine a to-be-monitored control channel resource based on the resource type of the time-frequency domain resource, thereby increasing control channel monitoring efficiency, increasing coverage, and reducing a latency.

In some embodiments, the signaling is used to indicate at least one of the following: the signaling is used to indicate that all resources of a physical downlink control channel candidate PDCCH candidate are downlink resources;

the signaling is used to indicate that all resources of a control channel element CCE are downlink resources; or

the signaling is used to indicate that all resources of a control resource set coreset are downlink resources.

In some embodiments, the signaling includes at least one of the following:

indication information, used to indicate a resource type of a time-frequency domain resource; or

determining information, used to determine information about a resource type of a time-frequency domain resource.

In some embodiments, the indication information includes a frequency domain format indicator FFI, and the FFI is used to indicate a time-frequency domain resource, and a resource type of the time-frequency domain resource.

In some embodiments, the signaling includes at least one of the following: radio resource control RRC signaling; group common group common DCI;

first scheduling DCI, used to schedule a single terminal;

second scheduling DCI, used to schedule a plurality of terminals in at least one cell in a cell group or at least one carrier in a carrier group; or

medium access control MAC control element CE signaling.

In some embodiments, the resource type includes at least one of the following: an uplink resource, a downlink resource, an unknown resource, an unavailable resource, resource identifier information, or resource monitoring information, where

the resource identifier information is used to identify a target control channel resource in a target slot; and

the resource monitoring information is used to indicate whether to monitor a control channel resource in the target slot.

The control channel monitoring method provided in this embodiment of this application may be executed by a control channel monitoring apparatus. In the embodiments of this application, an example in which the control channel monitoring apparatus performs the control channel monitoring method is used to describe the control channel monitoring apparatus provided in an embodiment of this application.

FIG. 10 is a schematic diagram 1 of a structure of a control channel monitoring apparatus according to an embodiment of this application. As shown in FIG. 10, a control channel monitoring apparatus 1000 is applied to a terminal, and includes:

a receiving module 1001, configured to receive signaling sent by a network-side device, where the signaling is used to indicate a resource type of a time-frequency domain resource; and

a determining module 1002, configured to determine a to-be-monitored control channel resource based on the resource type, indicated by the signaling, of the time-frequency domain resource.

In the control channel monitoring apparatus provided in this embodiment of this application, the network-side device indicates the resource type of the time-frequency domain resource by using the signaling. After the terminal receives the signaling sent by the network-side device, the resource type, indicated by the signaling, of the time-frequency domain resource can be obtained by parsing the signaling, so that the terminal can determine the to-be-monitored control channel resource based on the resource type of the time-frequency domain resource, thereby increasing control channel monitoring efficiency, increasing coverage, and reducing a latency.

The control channel monitoring apparatus in this embodiment of this application may be an electronic device, for example, an electronic device with an operating system, or may be a component in an electronic device, such as an integrated circuit or a chip. The operating system may be an Android operating system, an iOS operating system, or another possible operating system. This is not specifically limited in this embodiment of this application. The electronic device may be a terminal, or another device other than the terminal. For example, the terminal may include but is not limited to the foregoing listed types of the terminal 11, and another device may be a server, a Network Attached Storage (NAS), or the like. This is not specifically limited in this embodiment of this application.

In some embodiments, the determining module 1002 is configured to:

determine the to-be-monitored control channel resource based on a granularity and the resource type, indicated by the signaling, of the time-frequency domain resource; and/or

determine the to-be-monitored control channel resource in a control channel element CCE to a resource element group REG mapping CCE-REG mapping mode used by a control resource set coreset and based on the resource type, indicated by the signaling, of the time-frequency domain resource.

In some embodiments, the granularity includes at least one of the following: a PDCCH candidate granularity, a CCE granularity, or a coreset granularity.

In some embodiments, the determining module 1002 is configured to perform at least one of the following:

when the granularity is the PDCCH candidate granularity and the signaling indicates that all resources of a physical downlink control channel candidate PDCCH candidate are downlink resources, determining the PDCCH candidate as the to-be-monitored control channel resource;

when the granularity is the CCE granularity and the signaling indicates that all resources of a CCE are downlink resources, determining the CCE as the to-be-monitored control channel resource; or

when the granularity is the coreset granularity and the signaling indicates that all resources of a coreset are downlink resources, determining all PDCCH candidates in the coreset as the to-be-monitored control channel resource.

In some embodiments, the granularity is pre-defined in a protocol; the granularity is configured by the network-side device; or the granularity is determined by the terminal.

In some embodiments, the determining module 1002 is configured to perform at least one of the following:

when the CCE-REG mapping mode used by the coreset is interleaving, determining, as the to-be-monitored control channel resource, all PDCCH candidates in the coreset whose resources are all the downlink resources and that is indicated by the signaling; or

when the CCE-REG mapping mode used by the coreset is interleaving, determining, as the to-be-monitored control channel resource, the CCE whose resources are all the downlink resources and that is indicated by the signaling.

In some embodiments, the apparatus further includes:

a determining module, configured to determine to perform PDCCH overbooking and dropping based on the to-be-monitored control channel resource.

In some embodiments, the determining module is configured to perform at least one of the following:

when a granularity is a CCE granularity and all resources of at least one CCE of a PDCCH candidate on which the to-be-monitored control channel resource is located are downlink resources, determining to perform PDCCH overbooking and dropping based on an effective CCE included in the PDCCH candidate;

when a granularity is a CCE granularity and all resources of all CCEs of a PDCCH candidate on which the to-be-monitored control channel resource is located are downlink resources, determining to perform PDCCH overbooking and dropping based on the PDCCH candidate;

when a granularity is a PDCCH candidate granularity, determining to perform PDCCH overbooking and dropping based on the to-be-monitored control channel resource; or

when a granularity is a coreset granularity, determining to perform PDCCH overbooking and dropping based on the to-be-monitored control channel resource.

In some embodiments, the signaling includes at least one of the following:

indication information, used to indicate a resource type of a time-frequency domain resource; or

determining information, used to determine information about a resource type of a time-frequency domain resource.

In some embodiments, the indication information includes a frequency domain format indicator FFI, and the FFI is used to indicate a time-frequency domain resource, and a resource type of the time-frequency domain resource.

In some embodiments, the signaling includes at least one of the following:

radio resource control RRC signaling;

group common group common DCI;

first scheduling DCI, used to schedule a single terminal;

second scheduling DCI, used to schedule a plurality of terminals in at least one cell in a cell group or at least one carrier in a carrier group; or

medium access control MAC control element CE signaling.

In some embodiments, the resource type includes at least one of the following: an uplink resource, a downlink resource, an unknown resource, an unavailable resource, resource identifier information, or resource monitoring information, where

the resource identifier information is used to identify a target control channel resource in a target slot; and

the resource monitoring information is used to indicate whether to monitor a control channel resource in the target slot.

In some embodiments, the determining module 1002 is configured to: when the resource type includes the resource identifier information, determine, as the to-be-monitored control channel resource, the target control channel resource that is identified by the resource identifier information and that is in the target slot; and

when the resource type includes the resource monitoring information, and the resource monitoring information indicates that a control channel resource is monitored in the target slot, determine all time-frequency domain resources in the target slot as the to-be-monitored control channel resource.

In some embodiments, the terminal does not expect the coreset to be configured on an uplink bandwidth part UL BWP or a downlink DL BWP including an uplink subband UL subband.

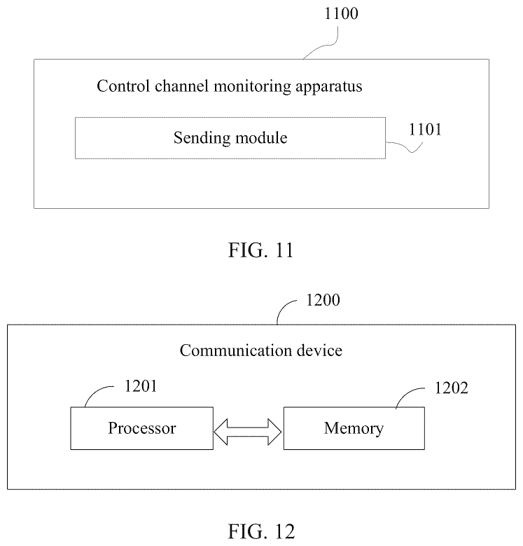

FIG. 11 is a schematic diagram 2 of a structure of a control channel monitoring apparatus according to an embodiment of this application. As shown in FIG. 11, the control channel monitoring apparatus 1100 is applied to a network-side device, and includes:

a sending module 1101, configured to send signaling to a terminal, where the signaling is used to indicate a resource type of a time-frequency domain resource.

In the control channel monitoring apparatus provided in this embodiment of this application, the network-side device indicates the resource type of the time-frequency domain resource by using the signaling. After the terminal receives the signaling sent by the network-side device, the resource type, indicated by the signaling, of the time-frequency domain resource can be obtained by parsing the signaling, so that the terminal can determine the to-be-monitored control channel resource based on the resource type of the time-frequency domain resource, thereby increasing control channel monitoring efficiency, increasing coverage, and reducing a latency.

In some embodiments, the signaling is used to indicate at least one of the following:

the signaling is used to indicate that all resources of a physical downlink control channel candidate PDCCH candidate are downlink resources;

the signaling is used to indicate that all resources of a control channel element CCE are downlink resources; or

the signaling is used to indicate that all resources of a control resource set coreset are downlink resources.

In some embodiments, the signaling includes at least one of the following:

indication information, used to indicate a resource type of a time-frequency domain resource; or

determining information, used to determine information about a resource type of a time-frequency domain resource.

In some embodiments, the indication information includes a frequency domain format indicator FFI, and the FFI is used to indicate a time-frequency domain resource, and a resource type of the time-frequency domain resource.

In some embodiments, the signaling includes at least one of the following:

radio resource control RRC signaling;

group common group common DCI;

first scheduling DCI, used to schedule a single terminal;

second scheduling DCI, used to schedule a plurality of terminals in at least one cell in a cell group or at least one carrier in a carrier group; or

medium access control MAC control element CE signaling.

In some embodiments, the resource type includes at least one of the following: an uplink resource, a downlink resource, an unknown resource, an unavailable resource, resource identifier information, or resource monitoring information, where

the resource identifier information is used to identify a target control channel resource in a target slot; and

the resource monitoring information is used to indicate whether to monitor a control channel resource in the target slot.

The control channel monitoring apparatus provided in this embodiment of this application can implement the processes implemented in the method embodiments in FIG. 2 to FIG. 9, and a same technical effect is achieved. To avoid repetition, details are not described herein again.

FIG. 12 is a schematic diagram of a structure of a communication device according to an embodiment of this application. As shown in FIG. 12, the communication device 1200 includes a processor 1201 and a memory 1202. The memory 1202 stores a program or an instruction executable by the processor 1201. For example, when the communication device 1200 is a terminal, the program or the instruction is executed by the processor 1201 to implement the steps of the embodiment of the foregoing control channel monitoring method, and a same technical effect can be achieved. When the communication device 1200 is a network-side device, when the program or the instruction is executed by the processor 1201, the steps of the embodiment of the foregoing control channel monitoring method are implemented, and a same technical effect can be achieved. To avoid repetition, details are not provided herein again.

An embodiment of this application further provides a terminal, including a processor and a communication interface. The communication interface is configured to receive signaling sent by a network-side device, and the signaling is used to indicate a resource type of a time-frequency domain resource; and

the processor is configured to determine a to-be-monitored control channel resource based on the resource type, indicated by the signaling, of the time-frequency domain resource. The terminal embodiment corresponds to the terminal side method embodiment, each implementation process and implementation of the method embodiment can be applied to the terminal embodiment, and a same technical effect can be achieved.

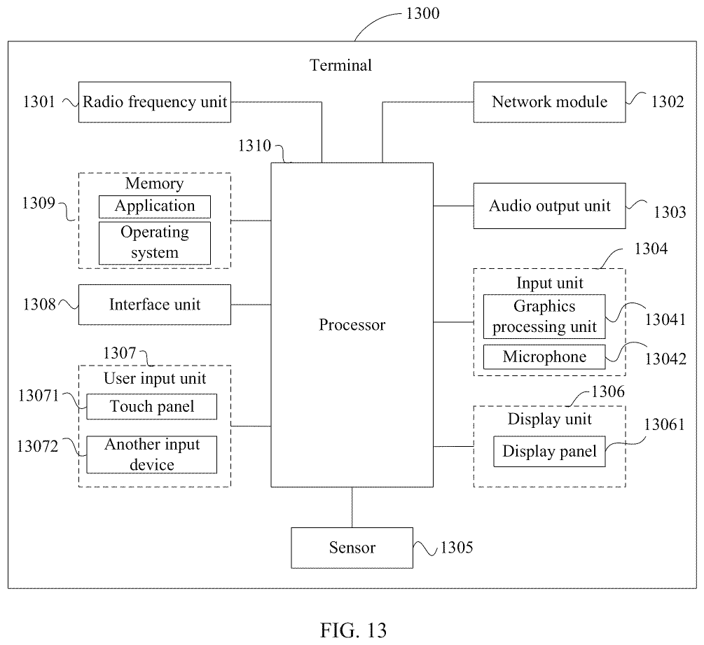

FIG. 13 is a schematic diagram of a structure of a terminal according to an embodiment of this application. As shown in FIG. 13, the terminal 1300 includes but is not limited to at least some components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art may understand that the terminal 1300 may further include a power supply (for example, a battery) that supplies power to each component. The power supply may be logically connected to the processor 1310 by using a power supply management system, to implement functions such as charging and discharging management, and power consumption management by using the power supply management system. The terminal structure shown in FIG. 13 constitutes no limitation on the terminal. The terminal may include more or fewer components than those shown in the figure, combine some components, or have different component arrangements. Details are not described herein.

It should be understood that in this embodiment of this application, the input unit 1304 may include a Graphics Processing Unit (GPU) 13041 and a microphone 13042. The graphics processing unit 13041 processes image data of a static picture or a video obtained by an image capture apparatus (for example, a camera) in a video capture mode or an image capture mode. The display unit 1306 may include a display panel 13061. The display panel 13061 may be configured in a form such as a liquid crystal display or an organic light-emitting diode. The user input unit 1307 includes at least one of a touch panel 13071 and another input device 13072. The touch panel 13071 is also referred to as a touchscreen. The touch panel 13071 may include two parts: a touch detection apparatus and a touch controller. The another input device 13072 may include but is not limited to a physical keyboard, a functional button (such as a volume control button or a power on/off button), a trackball, a mouse, and a joystick. Details are not described herein.

In this embodiment of this application, after receiving downlink data from a network-side device, the radio frequency unit 1301 may send the downlink data to the processor 1310 for processing. In addition, the radio frequency unit 1301 may send uplink data to the network-side device. Usually, the radio frequency unit 1301 includes but is not limited to an antenna, an amplifier, a transceiver, a coupler, a low noise amplifier, a duplexer, and the like.

The memory 1309 may be configured to store a software program or an instruction and various data. The memory 1309 may mainly include a first storage area for storing a program or an instruction and a second storage area for storing data. The first storage area may store an operating system, and an application program or an instruction required by at least one function (for example, a sound playing function or an image playing function). In addition, the memory 1309 may include a volatile memory or a non-volatile memory, or the memory 1309 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1309 in this embodiment of this application includes but is not limited to these memories and any memory of another proper type.

The processor 1310 may include one or more processing units. In some embodiments, an application processor and a modem processor are integrated into the processor 1310. The application processor mainly processes an operating system, a user interface, an application program, or the like. The modem processor mainly processes a wireless communication signal, for example, a baseband processor. It may be understood that the modem processor may not be integrated into the processor 1310.

The radio frequency unit 1301 is configured to receive signaling sent by a network-side device, where the signaling is used to indicate a resource type of a time-frequency domain resource; and

the processor 1310 is configured to determine a to-be-monitored control channel resource based on the resource type, indicated by the signaling, of the time-frequency domain resource.

Based on the terminal provided in this embodiment of this application, the network-side device indicates the resource type of the time-frequency domain resource by using the signaling. After the terminal receives the signaling sent by the network-side device, the resource type, indicated by the signaling, of the time-frequency domain resource can be obtained by parsing the signaling, so that the terminal can determine the to-be-monitored control channel resource based on the resource type of the time-frequency domain resource, thereby increasing control channel monitoring efficiency, increasing coverage, and reducing a latency.

An embodiment of this application further provides a network-side device, including a processor and a communication interface, where the communication interface is configured to send signaling to a terminal, and the signaling is used to indicate a resource type of a time-frequency domain resource. The network-side device embodiment corresponds to the foregoing method embodiment of the network-side device. Each implementation process and implementation of the foregoing method embodiment may be applicable to this network-side device embodiment, and a same technical effect can be achieved.

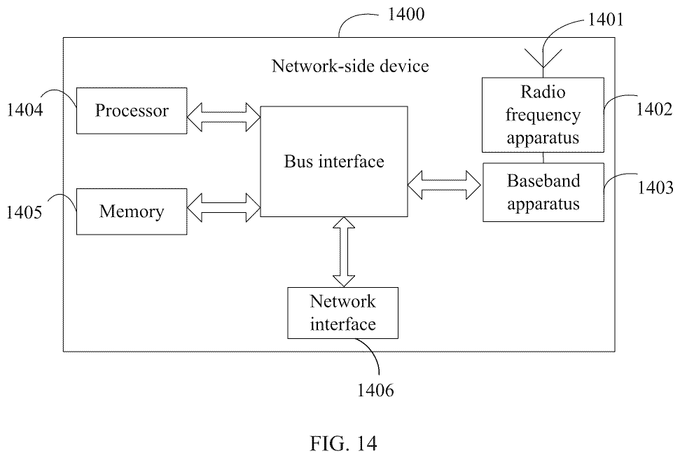

FIG. 14 is a schematic diagram of a structure of a network-side device according to an embodiment of this application. As shown in FIG. 14, the network-side device 1400 includes an antenna 1401, a radio frequency apparatus 1402, a baseband apparatus 1403, a processor 1404, and a memory 1405. The antenna 1401 is connected to the radio frequency apparatus 1402. In an uplink direction, the radio frequency apparatus 1402 receives information through the antenna 1401, and sends the received information to the baseband apparatus 1403 for processing. In a downlink direction, the baseband apparatus 1403 processes information that needs to be sent, and sends processed information to the radio frequency apparatus 1402. The radio frequency apparatus 1402 processes the received information, and then sends processed information through the antenna 1401.

In the foregoing embodiment, the method executed by the network-side device may be implemented in the baseband apparatus 1403. The baseband apparatus 1403 includes a baseband processor.

For example, the baseband apparatus 1403 may include at least one baseband board. A plurality of chips are disposed on the baseband board. As shown in FIG. 14, one chip is, for example, a baseband processor, and is connected to the memory 1405 by using a bus interface, to invoke a program in the memory 1405, to perform the operations of the network device shown in the foregoing method embodiment.

The network-side device may further include a network interface 1406, and the interface is, for example, a common public radio interface (CPRI).

The network-side device 1400 in this embodiment of this application further includes an instruction or a program stored in the memory 1405 and executable by the processor 1404. The processor 1404 invokes the instruction or the program in the memory 1405 to perform the method shown in FIG. 9, and a same technical effect is achieved. To avoid repetition, details are not described herein again.

An embodiment of this application further provides a control channel monitoring system, including a terminal and a network-side device, where the terminal may be configured to perform the steps of the control channel monitoring method on a terminal side, and the network-side device may be configured to perform the steps of the control channel monitoring method on a network-side device side.

An embodiment of this application further provides a readable storage medium. The readable storage medium may be volatile or non-volatile. The readable storage medium stores a program or an instruction, the program or the instruction is executed by a processor to implement the processes of the embodiment of the foregoing control channel monitoring method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction to implement the processes of the embodiment of the foregoing control channel monitoring method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the embodiment of foregoing control channel monitoring method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by a statement “includes a . . . ” does not preclude the presence of additional identical elements in the process, method, article, or apparatus that includes the element. In addition, it should be noted that the scope of the method and apparatus in the implementations of this application is not limited to performing functions in an illustrated or discussed sequence, and may further include performing the functions in a basically simultaneous manner or in a reverse sequence based on the functions concerned. For example, the described method may be performed in an order different from the described order, and steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific implementations. The foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for control channel monitoring, comprising:
receiving, by a terminal, signaling sent by a network-side device, wherein the signaling is used to indicate a resource type of a time-frequency domain resource; and
determining, by the terminal, a to-be-monitored control channel resource based on the resource type, indicated by the signaling, of the time-frequency domain resource.

2. The method according to claim 1, wherein the determining, by the terminal, a to-be-monitored control channel resource based on the resource type, indicated by the signaling, of the time-frequency domain resource comprises:
determining, by the terminal, the to-be-monitored control channel resource based on a granularity and the resource type, indicated by the signaling, of the time-frequency domain resource; or
determining, by the terminal, the to-be-monitored control channel resource in a control channel element (CCE) to a resource element group (REG) mapping (CCE-REG mapping) mode used by a control resource set (coreset) and based on the resource type, indicated by the signaling, of the time-frequency domain resource.

3. The method according to claim 2, wherein the granularity comprises at least one of the following: a physical downlink control channel (PDCCH) candidate granularity, a CCE granularity, or a coreset granularity.

4. The method according to claim 3, wherein the determining, by the terminal, the to-be-monitored control channel resource based on a granularity and the resource type, indicated by the signaling, of the time-frequency domain resource comprises at least one of the following:
when the granularity is the PDCCH candidate granularity and the signaling indicates that all resources of a PDCCH candidate are downlink resources, determining, by the terminal, the PDCCH candidate as the to-be-monitored control channel resource;
when the granularity is the CCE granularity and the signaling indicates that all resources of a CCE are downlink resources, determining, by the terminal, the CCE as the to-be-monitored control channel resource; or
when the granularity is the coreset granularity and the signaling indicates that all resources of a coreset are downlink resources, determining, by the terminal, all PDCCH candidates in the coreset as the to-be-monitored control channel resource.

5. The method according to claim 2, wherein the granularity is predefined in a protocol; the granularity is configured by the network-side device; or the granularity is determined by the terminal.

6. The method according to claim 2, wherein the determining, by the terminal, the to-be-monitored control channel resource in a CCE-REG mapping mode used by a coreset and based on the resource type, indicated by the signaling, of the time-frequency domain resource comprises at least one of the following:
when the CCE-REG mapping mode used by the coreset is interleaving, determining, by the terminal as the to-be-monitored control channel resource, all PDCCH candidates in the coreset whose resources are all downlink resources and that is indicated by the signaling; or
when the CCE-REG mapping mode used by the coreset is interleaving, determining, by the terminal as the to-be-monitored control channel resource, the CCE whose resources are all the downlink resources and that is indicated by the signaling.

7. The method according to claim 1, further comprising:
determining, by the terminal, to perform PDCCH overbooking and PDCCH dropping based on the to-be-monitored control channel resource.

8. The method according to claim 7, wherein the determining, by the terminal, to perform PDCCH overbooking and PDCCH dropping based on the to-be-monitored control channel resource comprises at least one of the following:
when a granularity is a CCE granularity and all resources of at least one CCE of a PDCCH candidate on which the to-be-monitored control channel resource is located are downlink resources, determining, by the terminal, to perform PDCCH overbooking and PDCCH dropping based on an effective CCE comprised in the PDCCH candidate;
when a granularity is a CCE granularity and all resources of all CCEs of a PDCCH candidate on which the to-be-monitored control channel resource is located are downlink resources, determining, by the terminal, to perform PDCCH overbooking and PDCCH dropping based on the PDCCH candidate;
when a granularity is a PDCCH candidate granularity, determining, by the terminal, to perform PDCCH overbooking and PDCCH dropping based on the to-be-monitored control channel resource; or
when a granularity is a coreset granularity, determining, by the terminal, to perform PDCCH overbooking and PDCCH dropping based on the to-be-monitored control channel resource.

9. The method according to claim 1, wherein the signaling comprises at least one of the following:
indication information, used to indicate a resource type of a time-frequency domain resource; or
determining information, used to determine information about a resource type of a time-frequency domain resource.

10. The method according to claim 9, wherein the indication information comprises a frequency domain format indicator (FFI), wherein the FFI is used to indicate a time-frequency domain resource, and a resource type of the time-frequency domain resource.

11. The method according to claim 1, wherein the signaling comprises at least one of the following:
radio resource control (RRC) signaling;
group common group common (DCI);
first scheduling DCI, used to schedule a single terminal;
second scheduling DCI, used to schedule a plurality of terminals in at least one cell in a cell group or at least one carrier in a carrier group; or
medium access control (MAC) control element (CE) signaling.

12. The method according to claim 1, wherein the resource type comprises at least one of the following: an uplink resource, a downlink resource, an unknown resource, an unavailable resource, resource identifier information, or resource monitoring information, wherein:
the resource identifier information is used to identify a target control channel resource in a target slot; and
the resource monitoring information is used to indicate whether to monitor a control channel resource in the target slot.

13. The method according to claim 12, wherein the determining, by the terminal, a to-be-monitored control channel resource based on the resource type, indicated by the signaling, of the time-frequency domain resource comprises:
when the resource type comprises the resource identifier information, determining, by the terminal as the to-be-monitored control channel resource, the target control channel resource, identified by the resource identifier information, in the target slot; and
when the resource type comprises the resource monitoring information, and the resource monitoring information indicates that the control channel resource is monitored in the target slot, determining, by the terminal, all time-frequency domain resources in the target slot as to-be-monitored control channel resource.

14. The method according to claim 1, wherein the terminal does not expect the coreset to be configured on an uplink bandwidth part (UL BWP) or a downlink (DL) BWP comprising an uplink subband (UL subband).

15. A method for control channel monitoring, comprising:
sending, by a network-side device, signaling to a terminal, wherein the signaling is used to indicate a resource type of a time-frequency domain resource.

16. The method according to claim 15, wherein the signaling is used to indicate to at least one of the following:
the signaling is used to indicate that all resources of a physical downlink control channel (PDCCH) candidate are downlink resources;
the signaling is used to indicate that all resources of a control channel element (CCE) are downlink resources; or the signaling is used to indicate that all resources of a control resource set coreset are downlink resources.

17. The method according to claim 15, wherein the signaling comprises at least one of the following:
indication information, used to indicate a resource type of a time-frequency domain resource; or
determining information, used to determine information about a resource type of a time-frequency domain resource.

18. The method according to claim 17, wherein the indication information comprises a frequency domain format indication (FFI), wherein the FFI is used to indicate a time-frequency domain resource, and a resource type of the time-frequency domain resource.

19. A terminal, comprising: a memory storing a computer program; and a processor coupled to the memory and configured to execute the computer program to perform operations comprising:
receiving signaling sent by a network-side device, wherein the signaling is used to indicate a resource type of a time-frequency domain resource; and
determining a to-be-monitored control channel resource based on the resource type, indicated by the signaling, of the time-frequency domain resource.

20. A network-side device, comprising:
a memory storing a computer program; and a processor coupled to the memory and configured to execute the computer program to perform the method according to claim 15.
